(19) United States
(12) Patent Application Publication
(10) Pub. No.: US 2013/0091224 A1
(43) Pub. Date: Apr. 11, 2013

(54) Managing Meetings Relative to Messages

(71) Applicants: Al Chakra, Apex, NC (US); Liam Harpur, Dublin (IE); Mark Kelly, Dublin (IE); John Rice, Waterford (IE)

(72) Inventors: Al Chakra, Apex, NC (US); Liam Harpur, Dublin (IE); Mark Kelly, Dublin (IE); John Rice, Waterford (IE)

(73) Assignee: INTERNATIONAL BUSINESS MACHINES CORPORATION, Armonk, NY (US)

(21) Appl. No.: 13/253,401

(22) Filed: Oct. 5, 2011

(51) Int. Cl. G06F 15/16

(52) U.S. Cl. 709/206

(57) ABSTRACT

Methods and systems of managing meetings may involve intercepting an outgoing message from a sender to a recipient, and conducting an analysis of the outgoing message with respect to a calendar associated with the sender. In addition, delivery of the message may be suspended if the analysis indicates that the sender and the recipient have a scheduled meeting. In one example, the outgoing message includes at least one of an email message, a chat message and a text message.

### BACKGROUND

Embodiments of the present invention generally relate to meeting management. More particularly, embodiments relate to the management of pre-existing meetings relative to outgoing messages.

It may be a common practice for individuals within an organization to send email messages to one another. Sometimes the sender of an email may not realize, however, that an upcoming meeting has already been scheduled between the sender and the recipient. Indeed, it may be the case that the topic of the email is better suited for face-to-face discussion (e.g., human resources or other confidential topics) than for email.

### BRIEF SUMMARY

Embodiments may involve a computer implemented method in which an outgoing message from a sender to a recipient is intercepted in response to at least one of a confidentiality condition, a keyword condition, a user level condition and a time sensitivity condition. The method can also provide for conducting an analysis of the outgoing message with respect to a calendar associated with the sender, wherein the analysis may include identifying a scheduled meeting between the sender and the recipient, comparing content of the outgoing message to an agenda of the scheduled meeting, and modifying the agenda based on the content of the outgoing message. In addition, the method may provide for suspending delivery of the outgoing message and notifying the sender of the scheduled meeting.

Embodiments may also include a computer program product having a computer readable storage medium and computer usable code stored on the computer readable storage medium. If executed by a processor, the computer usable code may cause a computer to intercept an outgoing message from a sender to a recipient in response to at least one of a confidentiality condition, a keyword condition, a user level condition and a time sensitivity condition. The computer usable code can also cause a computer to conduct an analysis of the outgoing message with respect to a calendar associated with the sender, wherein the analysis may include identifying a scheduled meeting between the sender and the recipient, comparing content of the outgoing message to an agenda of the scheduled meeting, and modifying the agenda based on the content of the outgoing message. If executed, the computer usable code may also suspend delivery of the outgoing message, and notify the sender of the scheduled meeting.

Embodiments may also include a computer program product having a computer readable storage medium and computer usable code stored on the computer readable storage medium. If executed by a processor, the computer usable code may cause a computer to intercept an outgoing message from a sender to a recipient, and conduct an analysis of the outgoing message with respect to a calendar associated with the sender. In addition, the computer usable code can cause a computer to suspend delivery of the outgoing message if the analysis indicates that the sender and the recipient have a scheduled meeting.

### BRIEF DESCRIPTION OF THE SEVERAL VIEWS OF THE DRAWINGS

The various advantages of the embodiments of the present invention will become apparent to one skilled in the art by reading the following specification and appended claims, and by referencing the following drawings, in which:

FIG. 1 is a block diagram of an example of a calendar entry modification according to an embodiment;

FIG. 2 is a flowchart of an example of a method of managing meetings according to an embodiment;

FIG. 3 is a flowchart of an example of a method of modifying a meeting agenda according to an embodiment; and

FIG. 4 is a block diagram of an example of a computing architecture according to an embodiment.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

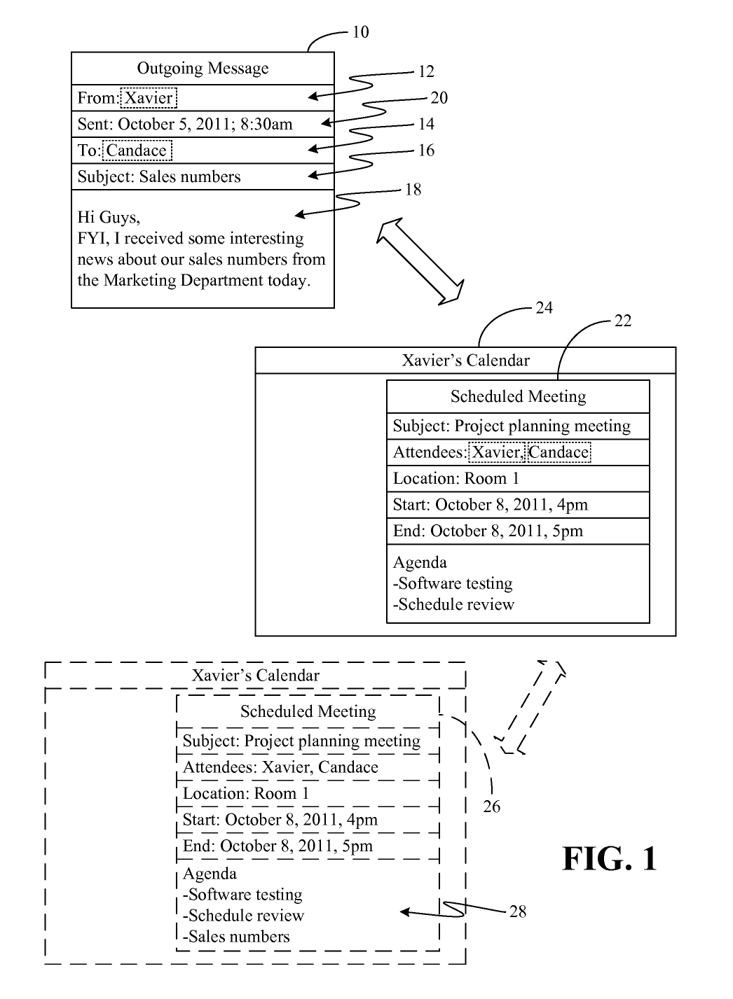

Referring now to FIG. 1, an outgoing message 10 from a sender (e.g., “Xavier”) 12 to a recipient (e.g., “Candace”) 14 is shown. Although the illustrated outgoing 10 message is an email message, the outgoing message 10 could also be an outgoing chat message (e.g., instant message/IM), text message (e.g., short messaging service/SMS, multimedia messaging service/MMS), or other type of written communication. In addition, the outgoing message 10 may have multiple recipients. The outgoing message 10 may generally include content such as a subject (e.g., “Sales numbers”) 16, a message body (e.g., “Hi Guys . . . ”) 18, a send time (e.g., “October 5, 2011; 8:30 am”) 20, etc.

In addition, a scheduled (e.g., pre-existing) meeting 22 between the sender 12 and the recipient 14 may be present in a calendar 24 associated with the sender 12 at the time the sender 12 attempts to transmit the outgoing message 10. As will be discussed in greater detail, the message content of the outgoing message 10 can be used to modify the scheduled meeting 22. In particular, a revised meeting 26 is generated in which an agenda (e.g., Notes and/or Subject section) 28 of the revised meeting 26 is modified to include the subject 16 and/or other content of the outgoing message 10, in the example shown. Accordingly, delivery of the outgoing message 10 may be suspended, wherein the sender 12 and recipient 14 can discuss the content of the outgoing message 10 face-to-face, via teleconference, etc.

Such an approach may ensure that adequate consideration is given to the subject 16 of the outgoing message 10, may enable supplementary information to be shared between the participants of the meeting, and may limit the potential for misinterpretations and/or misunderstandings. Moreover, the illustrated approach can reduce unneeded wired and/or wireless communications when there is a better alternative, may free up valuable bandwidth, and can decrease the load on networking resources. Simply put, the illustrated approach can enable speedy and efficient handling of important, and potentially confidential, topics.

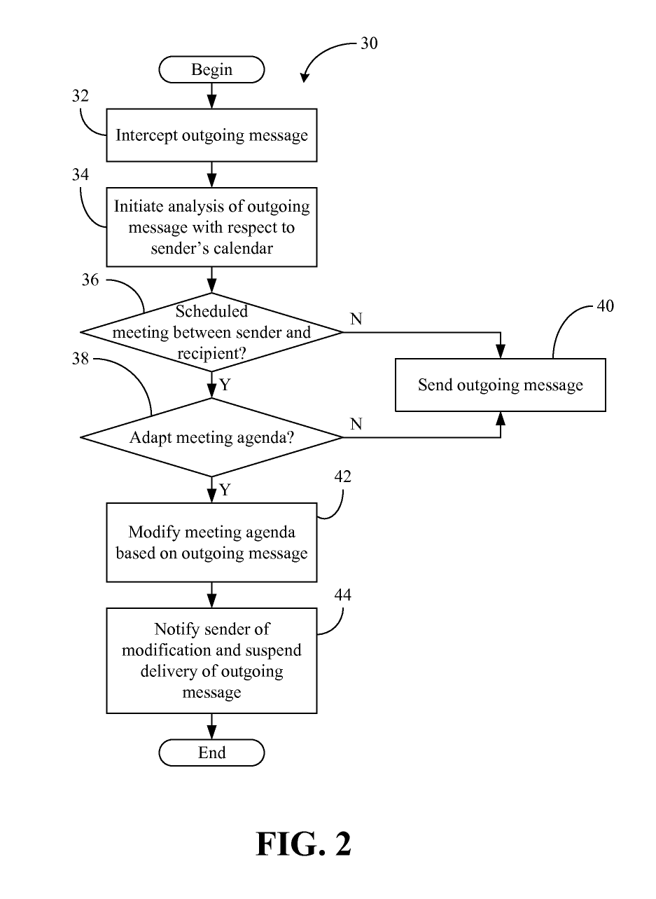

Turning now to FIG. 2, a method 30 of managing meetings is shown. The method 30 could be implemented in a messaging (e.g., email, chat, text) and/or calendaring tool running on a client device, a server, other computing platform, or any combination thereof. Illustrated processing block 32 provides for intercepting an outgoing message. As already noted, the outgoing message may be an email, chat, text message, and so forth, wherein the outgoing message could be authored using a wide variety of tools such as, for example, an email client, a texting interface (e.g., of a smart phone, personal digital assistant/PDA), a chat interface (e.g., of a handheld device, laptop, personal computer/PC), a social networking messaging interface, blog posting interface, etc.

Moreover, the interception of the outgoing message 32 may be initiated by the presence of a condition such as, for example, a confidentiality condition, a keyword condition, a user level condition, a time sensitivity condition, etc. For example, the confidentiality condition could include the outgoing message being marked confidential so that only sensitive messages (e.g., human resources, attorney-client privileged) are processed by the method 30. The keyword condition may include the presence of one or more prescribed terms (e.g., high priority project names, clients) in the outgoing message, wherein determining whether the keyword condition is present could include the application of one or more natural language rules to the content of the outgoing message. As will be discussed in greater detail, keywords and/or natural language processing may also be used to compare outgoing messages to scheduled messages.

Detecting the user level condition might involve determining whether the sender and/or recipient are classified at, above, or below certain hierarchical level in the organization. Additionally, detecting the time sensitivity condition could include a requirement that the outgoing message is not marked as urgent so that time sensitive messages are bypassed by the method 30 and delivered in a timely fashion. Other conditions may also be used to trigger implementation/execution of the method 30.

Illustrated block 34 initiates an analysis of the intercepted outgoing message with respect to the sender's calendar. In general, the analysis may involve identifying one or more scheduled meetings between the sender and recipient of the outgoing message, and comparing the content of the outgoing message to an agenda of the scheduled meeting. If it is determined at block 36 that a scheduled meeting/appointment exists between the sender and recipient of the outgoing message, a determination may be made at block 38 as to whether to adapt the agenda of the scheduled meeting. If the outgoing message includes multiple recipients, the determination at block 38 may be conducted on a recipient-by-recipient basis.

In one example, the block 38 could involve notifying the sender of the scheduled meeting and prompting the sender for permission to suspend delivery of the outgoing message (e.g., “Xavier and Candace are scheduled to have a meeting on Saturday afternoon . . . . Do you want this message delayed until the meeting on Saturday?”). In the case of multiple recipients, the notification/prompt may indicate to the sender the identities of the other recipients of the outgoing message as well as the identities of the expected participants in the scheduled meeting. Thus, the sender might be given the option of completing the transmission of the outgoing message if the message is directed to one or more recipients who will not be present at the scheduled meeting, or the scheduled meeting includes participants who are not recipients of the outgoing message. Other approaches might involve making the determination at block 38 without input from the user. Indeed, a policy could be implemented in which only outgoing messages having a single recipient and a corresponding scheduled meeting between only sender and recipient are subjected to the message delivery suspension techniques described herein.

The determination at block 38 may also include a relevance determination based on one or more keywords and/or natural language rules. For example, if one or more keywords (and/or their synonyms) extracted from the outgoing message are not present in the meeting data (and vice versa), it might be concluded that the outgoing message and scheduled meeting are not sufficiently relevant to one another. In such a case, it may be determined that the meeting agenda should not be adapted. If it is determined either at block 36 that the sender and recipient do not have a scheduled meeting or at block 38 that meeting agenda adaptation will not be used, block 40 may provide for sending the outgoing message according to normal message delivery protocols. The meeting agenda can be modified at block 42, wherein illustrated block 44 notifies the sender of the modification and suspends delivery of the outgoing message.

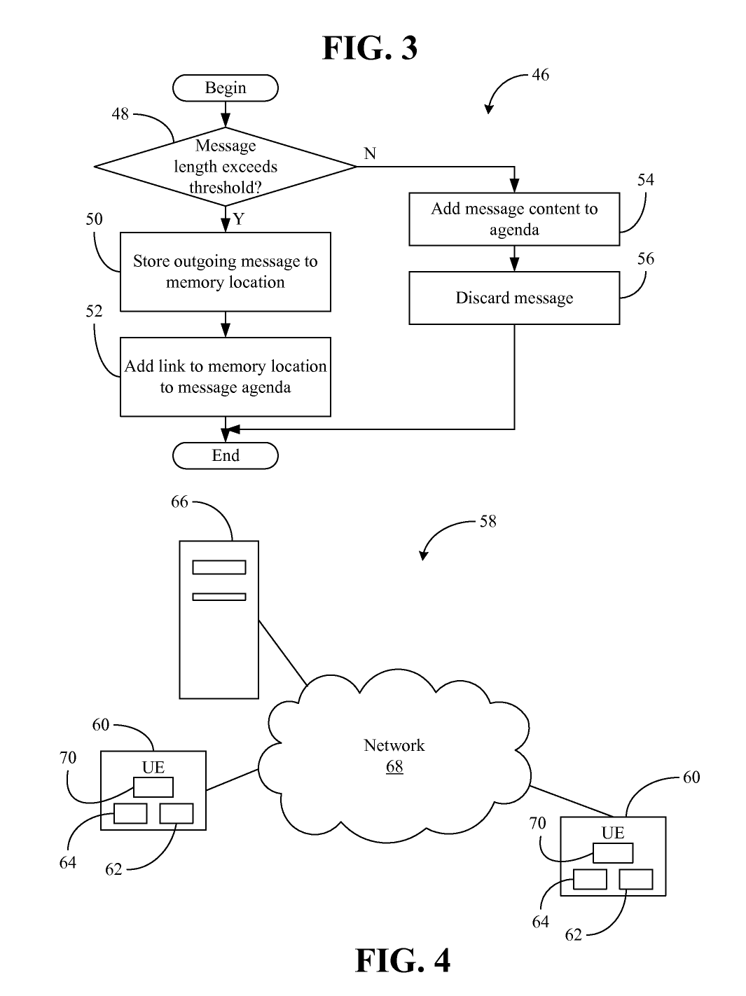

FIG. 3 demonstrates one approach to modifying a meeting agenda at method 46 in greater detail. Thus, the method 46 may be readily substituted for the processing block 42 (FIG. 2), already discussed. In particular, a determination may be made at block 48 as to whether the length of the outgoing message exceeds a certain threshold. The threshold could be a word count threshold, bit/byte size, percentage of the meeting agenda length, or other appropriate metric. If the message length exceeds the threshold, illustrated block 50 stores the outgoing message to a memory location (e.g., random access memory/RAM, read only memory/ROM, programmable ROM/PROM). In addition, a link associated with the memory location may be added to the message agenda at block 52.

If, on the other hand, it is determined at block 48 that the message length does not exceed the threshold, at least a portion of the content of the outgoing message may be added to the message agenda at block 54. The selection of content to be added to the agenda could be conducted on a keyword and/or natural language basis. For example, one or more keywords might be identified in the message content, wherein the meeting agenda is searched for the one or more keywords. If a match is not found for one or more of the keywords, those keywords (and/or the sentences/phrases containing the non-matching keywords) could be added to the agenda as new items/topics for discussion. In addition, one or more keywords could be identified in the meeting agenda, wherein the message content is searched for the one or more keywords. Indeed a combination of both approaches might be deployed, and one or more natural language rules (e.g., synonyms, dictionaries) may be applied in either case. Illustrated block 56 provides for discarding the outgoing message.

FIG. 4 shows a computing architecture 58 in which user equipment (UE) devices 60 include a messaging application 62 that enables the creation of messages between users of the UE devices 60. In addition, a messaging server 66 and a network 68 may enable the transfer of messages between the UE devices 60 based on sender and recipient data (e.g., metadata) associated with the messages. The network 68 can itself include any suitable combination of servers, access points, routers, base stations, mobile switching centers, public switching telephone network (PSTN) components, etc., to facilitate communication between the UE devices 60 and the server 66. The illustrated UE devices 60 also include a calendaring application 64 that enables the users of the UE devices 60 to schedule meetings/appointments with one another.

In one example, the UE devices 60 include a tool 70 to manage messages relative to meetings. In particular, the tool 70 may be configured to intercept outgoing messages from a sender to a recipient, conduct an analysis of the outgoing message with respect to a calendar associated with the sender, and suspend delivery of the outgoing message if the analysis indicates that the sender and recipient have a scheduled meeting, as already discussed. The tool 70 could be incorporated into the messaging application 62 or the calendaring application 64, or implemented as a stand-alone solution. Moreover, the tool 70 might be implemented on the server 66 or other cloud computing component as appropriate.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions. In addition, the terms “first”, “second”, etc. may be used herein only to facilitate discussion, and carry no particular temporal or chronological significance unless otherwise indicated.

Those skilled in the art will appreciate from the foregoing description that the broad techniques of the embodiments of the present invention can be implemented in a variety of forms. Therefore, while the embodiments of this invention have been described in connection with particular examples thereof, the true scope of the embodiments of the invention should not be so limited since other modifications will become apparent to the skilled practitioner upon a study of the drawings, specification, and following claims.

We claim:

1. A computer implemented method comprising:
intercepting an outgoing message from a sender to a recipient in response to at least one of a confidentiality condition, a keyword condition, a user level condition and a time sensitivity condition;
conducting an analysis of the outgoing message with respect to a calendar associated with the sender, wherein the analysis includes identifying a scheduled meeting between the sender and the recipient, comparing content of the outgoing message to an agenda of the scheduled meeting, and modifying the agenda based on the content of the outgoing message;
suspending delivery of the outgoing message; and
notifying the sender of the scheduled meeting.

2. The method of claim 1, wherein modifying the agenda includes adding at least a portion of the content of the outgoing message to the agenda, wherein the method further includes deleting the outgoing message.

3. The method of claim 1, further including:
determining that a length of the outgoing message exceeds a threshold; and
storing the outgoing message to a memory location, wherein modifying the agenda includes adding a link to the agenda, and wherein the link is associated with the memory location.

4. The method of claim 1, wherein comparing the content of the outgoing message to the agenda includes:
identifying one or more keywords in the content of the outgoing message; and
searching the agenda for the one or more keywords.

5. The method of claim 1, wherein comparing the content of the outgoing message to the agenda includes:
identifying one or more keywords in the agenda; and
searching the content of the outgoing message for the one or more keywords.

6. The method of claim 1, wherein comparing the content of the outgoing message to the agenda includes applying one or more natural language rules to at least one of the agenda and the content of the message.

7. The method of claim 1, wherein at least one of an outgoing email, an outgoing chat message and an outgoing text message are intercepted.

8. A computer program product comprising:
a computer readable storage medium; and
computer usable code stored on the computer readable storage medium, where, if executed by a processor, the computer usable code causes a computer to:
intercept an outgoing message from a sender to a recipient in response to at least one of a confidentiality condition, a keyword condition, a user level condition and a time sensitivity condition;
conduct an analysis of the outgoing message with respect to a calendar associated with the sender, wherein the analysis is to include identifying a scheduled meeting between the sender and the recipient, comparing content of the outgoing message to an agenda of the scheduled meeting, and modifying the agenda based on the content of the outgoing message;
suspend delivery of the outgoing message; and
notify the sender of the scheduled meeting.

9. The computer program product of claim 8, wherein at least a portion of the content of the outgoing message is to be added to the agenda and wherein, if executed, the computer usable code causes a computer to delete the outgoing message.

10. The computer program product of claim 8, wherein, if executed, the computer usable code causes a computer to:
determine that a length of the outgoing message exceeds a threshold; and
store the outgoing message to a memory location, wherein a link is to be added to the agenda, and wherein the link is to be associated with the memory location.

11. The computer program product of claim 8, wherein one or more keywords are to be identified in the content of the outgoing message, and the agenda is to be searched for the one or more keywords.

12. The computer program product of claim 8, wherein one or more keywords are to be identified in the agenda, and the content of the outgoing message is to be searched for the one or more keywords.

13. The computer program product of claim 8, wherein one or more natural language rules are to be applied to at least one of the agenda and the content of the message.

14. The computer program product of claim 8, wherein at least one of an outgoing email, an outgoing chat message and an outgoing text message are to be intercepted.

15. A computer program product comprising:
a computer readable storage medium; and
computer usable code stored on the computer readable storage medium, where, if executed by a processor, the computer usable code causes a computer to:
intercept an outgoing message from a sender to a recipient;
conduct an analysis of the outgoing message with respect to a calendar associated with the sender; and
suspend delivery of the outgoing message if the analysis indicates that the sender and the recipient have a scheduled meeting.

16. The computer program product of claim 15, wherein, if executed, the computer usable code causes a computer to:
identify the scheduled meeting;
compare content of the outgoing message to an agenda of the scheduled meeting; and
modify the agenda based on the content of the outgoing meeting.

17. The computer program product of claim 16, wherein a least a portion of the content of the outgoing message is to be added to the agenda and wherein, if executed, the computer usable code causes a computer to delete the outgoing message.

18. The computer program product of claim 16, wherein, if executed, the computer usable code causes a computer to:
determine that a length of the outgoing message exceeds a threshold;
store the outgoing message to a memory location, wherein a link is to be added to the agenda, and wherein the link is to be associated with the memory location.

19. The computer program product of claim 15, wherein at least one of an outgoing email, an outgoing chat message and an outgoing text message are to be intercepted in response to at least one of a confidentiality condition, a keyword condition, a user level condition and a time sensitivity condition
